(19) United States
(12) Patent Application Publication
(10) Pub. No.: US 2025/0179382 A1
(43) Pub. Date: Jun. 5, 2025

(54) UV PHOTO SCAVENGING OF HYDROGEN SULFIDE

(71) Applicant: CONOCOPHILLIPS COMPANY, Houston, TX (US)

(72) Inventor: Jay LOCKLEAR, Houston, TX (US)

(21) Appl. No.: 18/963,104

(22) Filed: Nov. 27, 2024

Related U.S. Application Data
(60) Provisional application No. 63/605,909, filed on Dec. 4, 2023.

(51) Int. Cl. C10L 3/10

(52) U.S. Cl. CPC C10L 3/103

(57) ABSTRACT

The disclosure provides a system for removal of hydrogen sulfide from oil and gas by the reaction of H₂S with hydrocarbons in the presence of a UV light source to produce easy to remove organosulfur compounds.

### PRIOR RELATED APPLICATIONS

This application claims priority to U.S. Ser. No. 63/605,909, filed on Dec. 4, 2023, and incorporated by reference in its entirety for all purposes.

### FEDERALLY SPONSORED RESEARCH STATEMENT

Not applicable.

### FIELD OF THE DISCLOSURE

The disclosure generally relates to removal of hydrogen sulfide gas from oil and gas streams.

### BACKGROUND OF THE DISCLOSURE

Hydrogen sulfide (H₂S) is a colorless, corrosive and flammable gas with a characteristic foul ‘rotten egg’ odor. H₂S is usually produced by naturally occurring sulfate reducing bacteria (SRB) which breakdown organic sulfur compounds. It is commonly found in wastewater treatment facilities and sewers, as well as in crude oil and gas.

H₂S is highly toxic and depending on the concentration and duration of exposure, can cause skin rashes, itchy eyes, and mild to serious respiratory issues or death. Low levels of H₂S exposure (25-600 ppm) usually produce local eye and mucous membrane irritation, while higher concentrations (>700 ppm) can cause loss of consciousness and sudden death. The Occupational Safety and Health Administration (OSHA) permissible exposure limit (PEL) for H₂S is 20 ppm, not to be exceeded at any time during an average 8-hour shift.

In addition to health risks, H₂S can also cause serious damage to drilling and production equipment. It is highly corrosive and can cause pitting, hydrogen-induced cracking and serious destruction to equipment, leading to immense infrastructure costs, safety hazards and production disruptions. Thus, mitigating H₂S induced corrosion and toxicity by controlling the level of H₂S in oil and gas is an important consideration in fields with high level of H₂S.

Crude oil and gas that contain high levels of H₂S is called ‘sour’. Removal of H₂S from a sour system is achieved in various ways, including mechanical, chemical, and biological mitigation methods. Biological methods are mostly used in municipal wastewater treatment facilities, not in oil and gas facilities, and therefore are not elaborated on herein.

Mechanical techniques, including flaring (burning) natural gas containing H₂S is a common technique to remove H₂S. However, burning is harmful for the environmental and is preferably avoided. Physical stripping of H₂S is another method but is less commonly used. Nitrogen stripping systems are used to strip H₂S from the crude oil, and then the gas is usually flared. This method usually causes a loss of light components in crude oil due to the high temperatures used in nitrogen stripping systems, as well as contributing to environmental degradation. It is also a highly energy intensive and time-consuming process as it is conducted in batches. In recent years membrane technology has been used as an alternative, but still has significant infrastructure and operating costs.

Use of H₂S scavengers and other chemical additives is a commonly used in the control of H₂S and removal of H₂S with chemicals is known as ‘sweetening’. Sweetening chemicals include different types of ethanolamines, including monoethanolamine (MEA), diethanolamine (DEA), diglycolamine (DGA) and methyldiethanolamine (MDEA), etc. Other H₂S scavenger chemicals commonly used are triazine based chemicals, as well as aldehydes and salts, such as sodium nitrate. These chemicals have direct injection application wherein they are directly mixed into a fluid stream where the H₂S in solution reacts with the H₂S scavenger chemical and is removed as a reaction byproduct.

For low H₂S levels of about <100 ppm, scavenger chemicals like triazine offer a cost-effective solution for removal of H₂S. However, when the H₂S levels are higher >200 ppm, large volumes of chemicals would be needed to effectively remove H₂S, and thus, the use of non-regenerative scavengers become prohibitively expensive. In such situations, regenerative scavengers like amine towers or reductive oxidation provides better alternatives.

In certain applications where more space is available for treatment of crude oil and gas, contactor towers are used wherein a feed gas is bubbled through a tower filled with scavenger chemical and the H₂S stripped gas is removed from the top of the tower. The efficiency of a contactor tower is usually greater than directly adding H₂S scavenger chemical to an oil and gas stream due to the high level of contact between reagents and H₂S the bubbler.

In an amine tower, sour gas is passed through a column filled with an amine solution, which reacts with the H₂S in the gas to form salts. H₂S stripped gas is collected at the end of the amine tower, and a regeneration solution is added to regenerate the amine in the tower for re-use. This is an efficient method for high levels of H₂S-containing gas. Redox systems are similar wherein H₂S is passed through an adsorption column containing a redox system. These redox systems usually consist of iron and chelating agents that react with H₂S producing sulfide salts and H₂S-free gas which is stripped off the system. The spent redox system can then be regenerated for further use. These methods are efficient, but these towers can be very large, and their use may be less feasible in facilities with space limitations.

Porous materials for the adsorption of H₂S are also used to mitigate H₂S levels. The porous materials are typically zeolites, carbon materials, activated carbon, porous metal oxides, mesoporous silica, compounds with metal-organic frameworks, etc. These materials lack mechanical stability, and their application can be complicated as adsorption of H₂S by these materials is dependent on the presence of other gases in the gas stream. Zeolites can adsorb gases such as CO₂ and water vapor in preference to H₂S, and thus their selection is based on a number of lab tests and that adds to operational cost.

Thus, although many methods for scavenging H₂S from oil and gas are available, what is needed in the art are more efficient, environmentally friendly, cost-effective methods for removal of H₂S from gas streams. The ideal method would have a small footprint, remove H₂S in the oil and gas stream without adverse reactions, would be easy to install and operate. Such a method would also not harm the equipment at the production facility, nor the environment, and would be reliable and have high efficiency. This invention addresses one or more of these needs.

### SUMMARY OF THE DISCLOSURE

Described herein are methods and systems for removing H₂S from sour gas using reaction of H₂S and either alkanes or alkenes (or both) with ultraviolet (UV) light to convert the H₂S to organosulfur compounds. The final H₂S concentration may be <100 ppm, or <15 ppm for some products, but can be as low as 3-4 ppm H₂S for many products. The total sulfur limit is not measured at many facilities, but may be as high as 20% or more at certain facilities. Thus, there may be no reason to remove the organosulfur products, although removal may be undertaken for certain product uses.

In preferred embodiments, the alkanes and/or alkenes already present in the sour gas are used for the photo-scavenging reaction, thus avoiding the need to provide any additional chemical. In other embodiments, alkanes and/or alkenes or other chemicals are added to optimize the reaction.

Not wishing to be bound by theory, we postulate that one or more of the following reactions with the components of sour gas may occur:

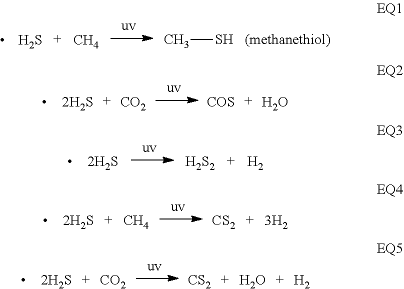

For olefins the reaction is believed to occur as follows:

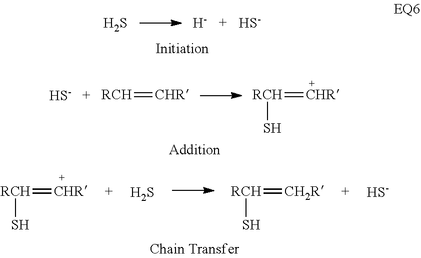

There are many other possible reactions and C—S can form chains as well, CH₃—(S—CH₂)ₙ—S—CH₃.

In order to implement this photo-scavenging system for treating sour gas, UV equipment, such as that used in water ozonation treatment plants, is modified to work with sour gas. Generally speaking, those systems are modified to reduce the risk of explosion, which is typically not a significant risk in a water treatment facility.

To reduce the risk of explosions, the equipment can be contained in a housing flushed with an inert gas or placed in a vacuum, but use of inert gas is preferred because there is a lower differential pressure between the produced gas and the chamber. The UV absorption profile of helium is lower than other common purge gases like nitrogen. Hence, helium is a preferred inert gas for this use.

Commercial ozonation equipment typically uses broad spectrum UV lights, which would be suitable for use in the inventive methods as H₂S has a broad absorbance spectrum with a peak around 190-195. Because the spectrum is broad, there is no need to focus on a specific wavelength and a generic broad spectrum UV light is sufficient to allow efficient photo scavenging, although that can be done if desired.

In a hydrocarbon production environment, the composition of the sour gas may change during production and have varying concentrations of light ends and contaminants. The sour gas is produced from a 3-phase separator, which takes reservoir fluid and separates the components to produce a gas stream, a water stream and an oil stream. The gas stream would not be dried and would have a variety of volatile organics in it, along with methane, ethane, carbon dioxide, water and the like. The sour gas is passed through a UV-reactor to produce cleaned gas.

The sale of gas has pre-defined mercaptan and total sulfur specifications. Thus, in many cases, the clean gas may be sold with all the mercaptans and other organosulfur compounds therein. Thus, there is no need to remove organosulfur compounds if within the specification for the sale of the gas. However, if the UV reaction products are heavier thiols like benzenethiol, these organosulfur compounds may be removed when needed for downstream uses. For example, organosulfur compounds may not be desired for use as a chemical feedstock, or in an LNG facility, but natural gas may be sold as is to consumers.

The method applies to gaseous streams, not oil or water. However, if oil has too high an H₂S concentration, one may simply reduce pressure so that H₂S is released from the crude as a gas with some of the lighter components, and the sour gas then treated as described herein. Once the H₂S is reduced, there is no further treatment, the gas can be sold commercially as long as the total sulfur is within specification. In other embodiments, the organosulfur is then removed using known or to be developed methods.

In general, a gas stream containing H₂S and alkane(s) or alkene(s) is treated as is or it can be mixed with gaseous alkane(s) or alkene(s) or even with a photo-initiator. This combination is passed through a high intensity UV lamp, which is believed to initiate the reactions illustrated above.

Any gaseous alkane can be used. The ideal alkane will also be cheap, readily available, non-toxic, not have negative impacts on the hydrocarbon stream or equipment, and be vaporizable at the temperature of the UV-reactor. The alkanes may thus contain 2-12, 2-10, 2-8, 4-8, 2-6 or 2-4 carbon atoms, although larger alkanes are used at higher temperatures to gasify them. Although the natural components of sour gas requiring no addition nor piping are good, larger alkanes are preferred in some embodiments as the boiling point of larger organosulfur compounds are higher and those components may be mixed with the crude that has less stringent specification for sulfur than natural gas. Thus, methane, ethane, propane, butane and CO₂ may be used, but higher chain alkanes like pentane, hexane, nonane, hexadecane, dodecane or combinations thereof may also be favored in certain applications.

Any gaseous olefin/alkene can be used provided it has at least one double bond, but preferred alkene may have fewer double bonds. The ideal alkene will also be cheap, readily available, non-toxic, nor have negative impacts on the hydrocarbon stream or equipment and be readily vaporizable. The alkene may thus contain 2-12, 2-10, 2-8, 4-8, 2-6 or 2-4 carbon atoms, although larger alkenes may be used at higher temperatures and may be preferred for the same reasons that larger alkanes may be preferred. The olefins thus include ethylene, propylene, but-1-ene, but-2-ene, isobutene, pentene, pent-2-ene, hexene, heptene, and octene. Larger alkenes include 3-nonene, 5-decene, cyclic alkenes like cyclohexene and cyclooctene.

In some embodiments, the alkanes and/or alkenes may also have other functional groups that do not react with H₂S under UV light, such as carbonyl, halides, nitrogen, and the like. The use of any of these functional groups depend on the stability of the functional group under the UV light and/or interactions with the hydrocarbon stream. In some embodiments, olefinic esters are used for reaction with H₂S as they are readily and cheaply available as vegetable or tree oils and the C═O ester group does not readily react under UV to produce any undesirable side-products (see SCHWAB 1968).

Although we anticipate that catalysts will not be required for this reaction, in some embodiments they may be helpful. Thus, NO₂, O₂, acetone, acetophenone and derivatives, benzoyl peroxide, 2,2-dimethoxy-2-phenylacetophenone, azobisisobutyronitrile, or other photoinitiators may be added in small amounts where the reaction is slow or inefficient.

The organosulfur compounds produced during the reaction may be continually removed from the system, so as to drive the reaction to completion, thereby consuming all of the H₂S in the feed gas. Alternatively, they may be batch removed or even left in, depending on the level of total sulfur and the end use requirements.

The organosulfur compounds can be removed by any means known in the art or to be developed. In some examples, the removal is carried out by passing the reaction products over a bed of caustic solution, such as sodium hydroxide, potassium hydroxide, common H₂S scavengers, or combinations thereof. Commonly used oxidizing agents may also be used to remove the organosulfur compounds produced during the reaction. Exemplary oxidizing agents include sodium hypochlorite, peracetic acid (PAA) or hydrogen peroxide. Other methods of removing mercaptans include absorbents, such as SULFATREAT®, ULFURTRAP® or SULPHINOL®, which also can remove trace amounts of H₂S, and thus may be preferred.

UV light covers a wavelength range of 100-400 nm. Although the reaction described herein can be carried out using the entire range of UV radiation, UV radiation of about 250-350 or 180-200 nm may be preferred. Most preferred is about 196 nm as it leads to complete reaction with no side reactions and unreacted products, at least as applied to C19 olefins. Other alkanes/alkenes may have different optima.

Similarly, any other high energy radiation such as X-rays, γ-rays and β-rays will convert H₂S into H′ and HS' radicals, but the subsequent chain reaction in the presence of other sources of energy is slow and may yield lower amounts of organosulfur compounds. Nonetheless, these are other possible energy sources that could be used herein.

Any commercially available UV light system can be fitted in the systems described herein. Medical-grade UV light systems are generally compact and lightweight with a long-lasting battery life and may be preferred, or water ozonation lamps may be preferred. Although mercury-based UV lamps can be used, due to the increased regulation and disposal cost associated with mercury-based lamps, smaller LED-based UV lamps may be better suited for applications herein described.

Any UV transmissible material can protect the UV lamp and/or house the gas, yet allow UV transmission. Fused quartz, fused silica or quartz glass is a glass consisting of almost pure silica (silicon dioxide, SiO₂) in amorphous (non-crystalline) form and the optical transmission of pure silica extends well into the ultraviolet. Common soda-lime glass, such as window glass, is partially transparent to UVA, but is opaque to shorter wavelengths, passing about 90% of the light above 350 nm, but blocking over 90% of the light below 300 nm. Fused quartz, depending on quality, can be transparent even to vacuum UV wavelengths. Crystalline quartz and some crystals such as CaF₂ and MgF₂ transmit well down to 150 nm or 160 nm wavelengths. Wood's glass is a deep violet-blue barium-sodium silicate glass with about 9% nickel oxide developed during World War I to block visible light for covert communications. Its maximum UV transmission is at 365 nm, one of the wavelengths of mercury lamps. There are also UV transmissible plastics, such as acrylics (see Polycast™ UVT (Professional Plastics CA) or ACRYLITE® Alltop (Röhm DK).

Reaction of H₂S with the alkane and/or alkene is preferably carried out in a reactor loop, which is a piping system that circulates the sour gas under the UV lamps for a time period. However, this is not essential, and other systems could be used, such as a bubbler tower, etc. The loop piping should also be a UV transmissible material, as described above. Typical reactor loop is made with UV penetrable plastics, such as UV transmitting acrylics, plexiglass, or the various quartz and glass materials discussed above.

The entire reactor loop plus UV lamp system may be encased in a unit called the UV-reactor unit herein. The UV-reactor unit housing is preferably made with UV-resistant material, such as UV-stable plastics, including high density polyethylene (HDPE), polycarbonate, polyamide-imide (PAI), polyvinylidene fluoride (PVDF), polytetrafluoroethyele (PTFE), and the like. Also, preferred, the housing protects plant workers from accidental UV exposure, being opaque to UV.

The piping can be any suitable configuration that provides sufficient UV exposure. Thus, a back-and-forth configuration of piping, with lamps placed between the piping is one arrangement. However, other arrangements are possible, including having the loops circumnavigate a UV lamp, preferably a 360° lamp, lining walls of a reactor with UV lamps and winding the piping back and forth inside the reactor. Combinations are also possible, e.g., a central lamp and wall mounted lamps.

In yet other embodiments, the UV reactor contains a plurality of UV lamps, either lining the reactor or in stacked arrays, or combinations thereof. The gas passes through the reactor without separate piping, merely being inside the housing. In such an embodiment, the multiple panels of UV lights inside the reactor ensures adequate irradiation.

In other embodiments, the UV reactor unit housing is purged with an inert gas to avoid reactions with the UV that might attenuate the energies and to reduce risk of explosion, the sour gas being safely contained in the piping. Inert gases such as helium, argon, nitrogen, and the like can be used. These can be piped in from a nearby source, or a gas canisters fluidly connected to the UV-reactor.

The amount of alkane or alkene added (if any) with the H₂S containing oil and gas stream is adjusted according to the concentration of H₂S and varied concentrations of H₂S in the crude oil and gas can be treated and removed by the method and systems described herein. In some embodiments, concentrations of H₂S up to 2500 ppm are reacted with alkane or alkene hydrocarbon under UV light. Generally, crude oil and gas containing H₂S concentrations of 20-2000 ppm, 20-1500 ppm, 100-1500 ppm, 20-1000 ppm, 100-1000 ppm, 200-1000 ppm, 20-800 ppm, 100-800 ppm, or 200-800 ppm, can be removed using the presently described method.

The systems for mitigating H₂S in hydrocarbon streams include at least a pipeline or a reactor equipped with a strong UV light source, that is fluidly connected to various up and down-stream components. Preferably, a first H₂S sensor is included upstream or at or near the inlet so that the operator knows what level of H₂S needs to be mitigated. However, this sensor may be optional if the amount is otherwise already known, which may be true for certain sour fields. A second H₂S sensor is included at or near the outlet or downstream thereof to establish the level of removal that was achieved and to quantify any remaining H₂S.

Preferably the UV reactor is insulated and/or heated, so that the temperature can be controlled. Ideal temperatures for the UV reaction may vary based on the size of the olefin, but a typical temperature for the reaction is room temperature for alkane and alkene gases, but increases with the size of the hydrocarbon. Hexene, for example has a boiling temperature of 145° F.

Any commercially available portable and precise H₂S sensor can be used, and such sensors preferably can detect at least 1 ppm and up to 2000 ppm or more H₂S and can record and/or transmit data. Care should be taken to test the H₂S sensor for sensitivity to mercaptans as some H₂S sensors also detect H₂S from mercaptans. Tunable diode lasers for H₂S measurement are well suited for this method as they are accurate and have a quick measurement and sampling time of ˜1 second. These can be adapted to and attached to any other components of the system, and have a range of temperature sensitivity. This flexibility in application makes these kind of H₂S sensors suitable for use herein.

Upstream components may be any components typically included in refineries, including crude oil, produced water and gas separators, and primary gas treatment facilities. One example of primary gas treatment may include treating sour gases in “amine units” or gas sweetening units which produce a stream of acid or sour gas (enriched in hydrogen sulfide) and a stream of desulfurized fuel or product gases, largely depleted of hydrogen sulfide. The primary gas treatment facilities, including amine units, operate more or less continuously and typically include an absorber, a regeneration system comprising heat exchangers, a reboiler, and a stripping column and normally make use of pumps to continuously circulate solvent back and forth between the absorber and the regeneration system. Such a system will thus feed the H₂S containing gas directly or indirectly into the UV-reactor as described herein.

Other upstream units may for example, add alkane or alkene and other chemicals as needed. A separator or demister may also be included upstream to remove any remaining entrained liquids and a mixer unit may be added if chemicals are to be added to the gas stream. In some examples, a de-butanizer may be added to remove heavier mercaptans along with butane from the sour gas stream.

Downstream equipment includes units to e.g., optionally remove organosulfur compounds, and if small amounts of H₂S remain, may include additional scrubbers to remove same. Organosulfur compound removal reactors may be based on adsorption, photocatalytic oxidation, catalytic incineration, decomposition, biological degradation, catalytic oxidation, and the like. Liquid non-regenerative H₂S scavengers like triazine, or triazine-based chemicals, aldehydes like glyoxal, acrolein, glutaraldehyde, and salts such as sodium nitrate may also be used for the removal of organosulfur compounds. An absorption reactor with SULFURTRAP® EX or SULFURTRAP® LH (CHEMICAL PRODUCTS INDUSTRIES INC., OK)—a high capacity, easy-changeout, iron-based, H₂S and mercaptan removal adsorbent for gas purification applications may be preferred as removing both mercaptans and residual H₂S. SULPHINOL® (SHELL® CATALYSTS & TECHNOLOGIES, TX) and UOP MEROX® (Honeywell UOP) also offer one step removal of acid gases (H₂S, CO₂) and trace organic sulfur (mercaptans, disulfides, thioethers, etc.).

If needed, 1-2 or more downstream scrubbers (secondary scrubbers) are fluidly connected to the loops of the UV reactor unit. However, the system may not need any such additional scrubber if organosulfur compound removal and H₂S removal by absorption are sufficient.

Downstream scrubbers or reactors to remove H₂S may use the Claus process, the GT-SPOC process, the GT-DOS-Direct catalytic oxidation process, the Stretford process, Small Stretford reactor, the Lo-Cat process, the sulferox process, the Thiopaq O&G process, the CrystaSulf process or any other process that may be developed. However, preferably, the UV light intensity and degree of exposure are set so as to avoid the need for any downstream scrubbers.

Once fully cleaned, the sweet gas may be routed to e.g., an LNG liquification unit, to storage, distribution or used in maintaining the system, e.g., used as a fuel to heat steam boilers or generate electricity and the like.

The invention includes any one or more of the following embodiments, in any combination(s) thereof.
A method for removing H₂S from reservoir fluids, said system comprising: a) separating a produced reservoir fluid into a produced water stream, a crude oil stream and a sour gas stream, said sour gas stream comprising >20 ppm H₂S and one or more alkane(s) or alkene(s) or both; b) exposing said sour gas stream to sufficient UV to convert said H₂S and said one or more alkane(s) or alkene(s) or both to an organosulfur compound and a sweet gas with zero or trace H₂S; c) optionally removing said organosulfur compound and said zero or trace H₂S from said sweet gas; and d) storing, distributing or liquifying said sweet gas.
A system for removing H₂S from reservoir fluids, said system comprising: a) a separator for separating a produced reservoir fluid into a produced water stream, a crude oil stream and a sour gas stream, said sour gas stream comprising >20 ppm H₂S and one or more alkane(s) or alkene(s); b) a UV reactor unit comprising UV transparent piping fluidly connected to said sour-gas stream and having one or more UV lights adjacent said piping and configured to emit sufficient UV light to an interior of said piping to convert said sour gas to an organosulfur compound and clean gas stream; c) said organosulfur compound and clean gas stream fluidly connected to a storage or distribution system.

Any method or system herein described, wherein said organosulfur compound is a mercaptan.

Any method or system herein described, wherein said organosulfur compound and/or said zero or trace H₂S are removed using a scavenger selected from a group consisting of triazine, or methanolamine (MEA), diethanolamine (DEA), diglycolamine (DGA), methyldiethanolamine (MDEA), and combinations thereof.

Any method or system herein described, wherein said organosulfur compound and/or said zero or trace H₂S are removed with an absorbent.

Any method or system herein described, wherein a UV reactor unit is contained within a housing, and said housing is purged with an inert gas.

Any method or system herein described, wherein said housing is UV opaque.

Any method or system herein described, further comprising an H₂S sensor upstream of said UV reactor unit, or an H₂S sensor downstream of said UV-reactor unit or both. These sensors are used for measuring H₂S levels before or after treatment.

Any method or system herein described, wherein said piping comprises acrylic.

Any method or system herein described, wherein said piping comprises quartz glass.

Any method or system herein described, said UV reactor comprising a heater.

Any method or system herein described, said UV reactor comprising a heater or being insulated or both.

Any method or system herein described, further comprising the devices and/or uses of one or more of: a) a demister upstream of said UV reactor; b) a primary gas treatment unit upstream of said UV reactor; c) a mixer upstream of said UV reactor; d) a debutanizer upstream of said UV reactor, e) a scrubber upstream of said storage or distribution system for removing said organosulfur compound; or f) an LNG liquefaction unit upstream of said storage or distribution system for liquifying said clean gas stream.

The use of the word “a” or “an” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim. The phrase “consisting of” is closed and excludes all additional elements. The phrase “consisting essentially of” excludes additional material elements, but allows the inclusions of non-material elements that do not substantially change the nature of the invention, such as instructions for use, buffers, and the like. Any claim or claim element introduced with the open transition term “comprising,” may also be narrowed to use the phrases “consisting essentially of” or “consisting of,” and vice versa. However, the entirety of claim language is not repeated verbatim in the interest of brevity herein.

The following abbreviations are used herein:

TABLE 1
Abbreviations

| ABBREVIATION | TERM |
|---|---|
| BTEX | Benzene, toluene, ethylbenzene and xylenes |
| DEA | Diethanolamine |
| HDPE | High density polyethylene |
| IR | Infra-red |
| MEA | Monoetholamine |
| PAA | Peracetic acid |
| PAI | Polyamide-imide |
| PEL | Permissible exposure limit |
| PTFE | Polytetrafluoroethylene |
| PVDF | Polyvinylidene fluoride |
| RT | Room temperature |
| SRB | Sulfur reducing bacteria |
| TDL | Tunable diode laser |
| UV | Ultraviolet |

### BRIEF DESCRIPTION OF THE DRAWINGS

FIG. 1 shows a UV reactor wherein the piping wraps around a 360° UV lamp.

FIG. 2 shows the UV reactor of FIG. 1 in a series of three reactors, preceded by a separator.

FIG. 3 shows a UV reactor wherein the lamps (only two shown) are housed in or adjacent the wall of the reactor.

FIG. 4 shows a variation of FIG. 2 with upstream demister and mixer, and downstream scrubber, LNG and storage units.

FIG. 5 shows a cross section of a UV reactor with stacked panels of UV lamps, wherein the gas is free within the housing.

### DETAILED DESCRIPTION

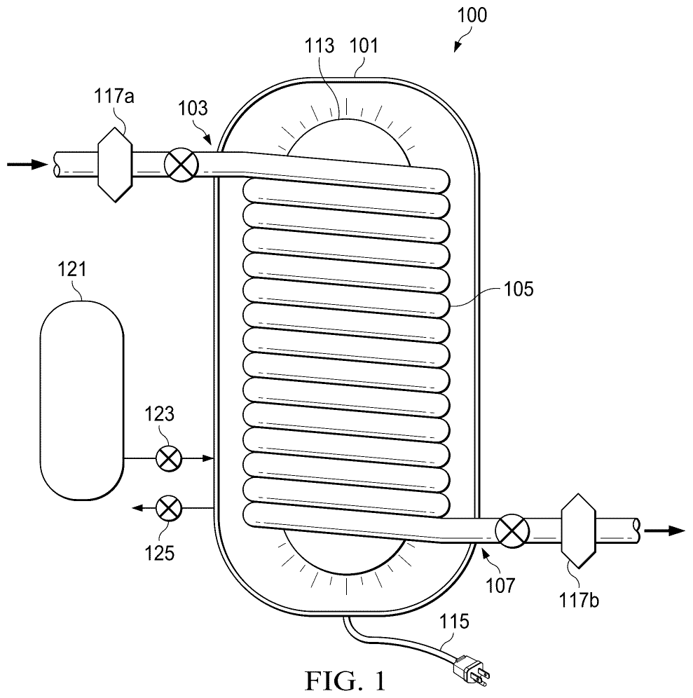

FIG. 1 shows one embodiment of a UV-reactor 100 for a sour gas treatment from an oil and gas facility. Sour gas enters reactor housing 101 via inlet 103 and proceeds via piping 105 through the unit 100. Piping 105 is UV transmissible and is wrapped around UV lamp 113 and eventually clean gas exits at outlet 107. Housing 101 is preferably UV opaque, and the interior is purged with Helium from tank 121, which enters via inlet 123 and excess gas is purged via outlet 125. H₂S sensors 117a and 117b are also seen, up and downstream of the UV-reactor 100, respectively. Wires 115 provide electricity to the UV reactor 100.

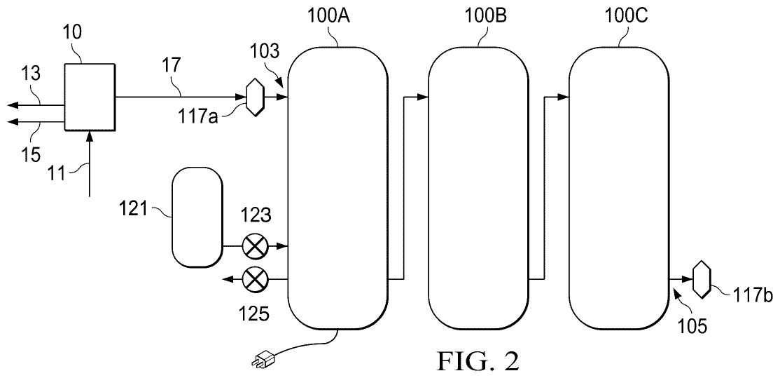

FIG. 2 shows the upstream separator 10 which accepts reservoir fluid stream 11, and separates it into a water stream 13, an oil stream 15, and a sour gas stream 17. This is upstream of three UV reactors 100A, 100B and 100C connected in series. Otherwise, the numbering is the same as in FIG. 1.

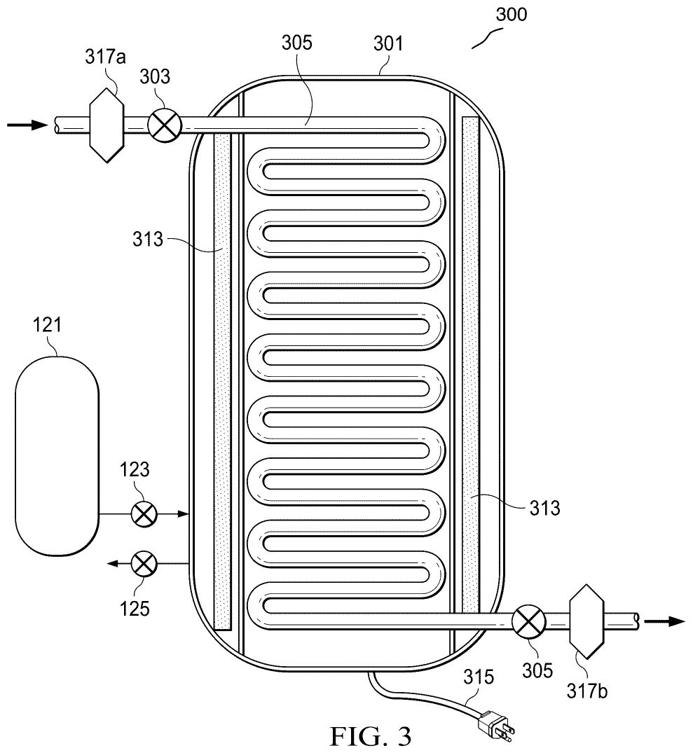

FIG. 3 shows an alternate arrangement of a UV-reactor 300 with housing 301. Here the UV lamps 313 are in the housing walls (2 shown for simplicity) and UV transparent sour gas piping 305 is looped back and forth inside the reactor 300 with the lamps 313 surrounding the piping 305. 303 is the sour gas inlet and 305 is the clean gas outlet. H₂S sensors 317a and 317b and are seen, and the helium purge system uses the same numerals as in FIG. 1. Wires 315 provide electricity to the UV reactor 300.

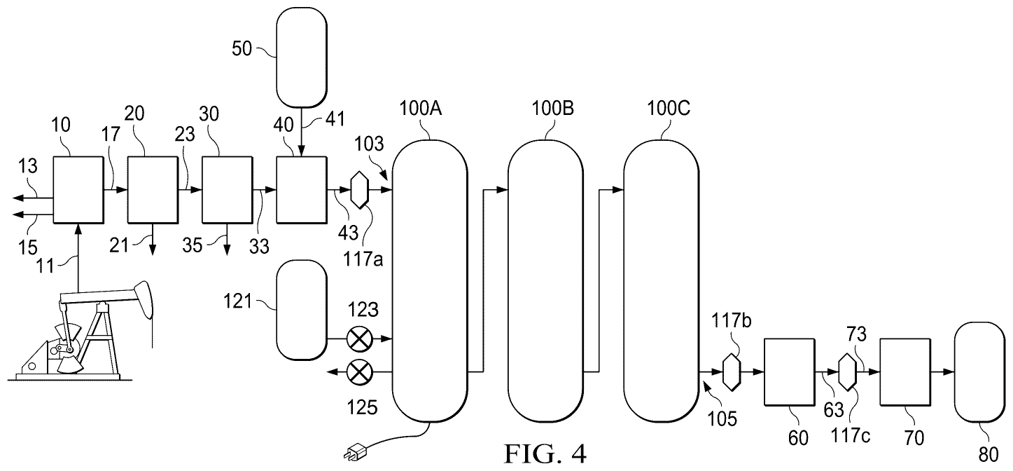

FIG. 4 is similar to FIG. 2 but includes additional but optional up- and down-stream components. After separator 10 there is fluidly connected a primary gas treatment unit 20 with clean gas outlet 21 and an enriched sour gas outlet line 23 fluidly connected with demister 30 for removing any entrained fluids via fluid outlet 35. Sour gas continues via dry sour gas outlet line 33 to mixer 40 with inlet line 41 fluidly connected from supply tank 50 for adding any alkane, alkene or other chemical to the sour gas. Once mixed, the sour gas then passes via mixed sour gas outlet line 43 to the optional H₂S sensor 117a and UV-reactors 100A-C. Once cleaned, as confirmed by optional sensor unit 117b, the clean gas travels to scrubber 60 for removing organosulfur compounds and any trace H₂S. Outlet line 63 then passes the sulfur-free clean gas to an LNG unit 70 leading via outlet line 73 to storage tank 80. If desired, an additional H₂S and/or sulfur sensor 117c could be included on outlet line 63.

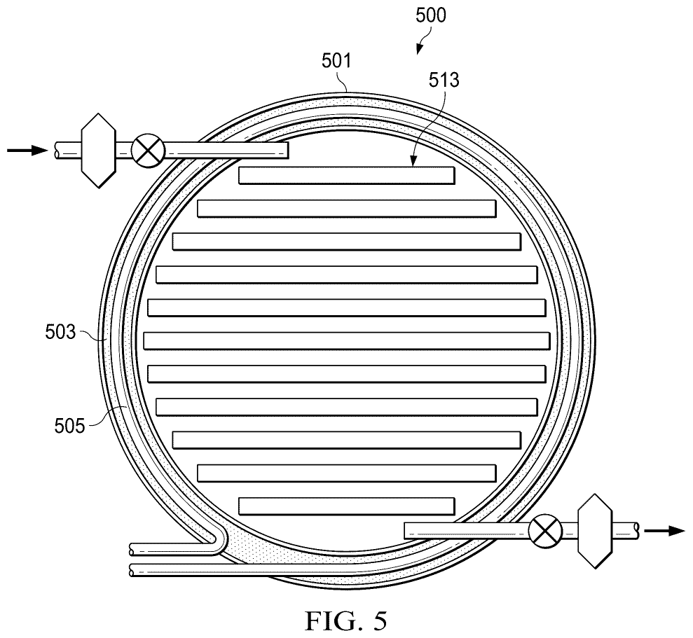

FIG. 5 shows a cross section of a UV reactor 500 with stacked panels of UV lamps 513, wherein the gas is free within the housing 501. The housing 501 is insulated 503 and has electric heating elements 505 between the wall of the housing 501 and the insulation 503. Such embodiment lacks the inert gas and thus may be too risky with certain highly explosive sour gases and/or higher temperatures. However, with some gases the inert gas purge may not be needed.

### Example 1

A proof-of-concept experiment was carried out using a methane gas containing 2% carbon dioxide gas and 500 ppm of H₂S gas. The system for the experiment was designed for benchtop use with limited space availability, and thus, the reactor unit loop with reactor loop and UV lamp (290 nm) was about 36×6×6 inches in dimension. Herein, the molar ratio of CH₄/CO₂/H₂S was about 98.95/2/0.05. The test was done at room temperature, and the entire system purged with helium throughout.

The sour gas mixture was sent through the UV reactor unit containing loop piping made with six 12″ quartz tubes allowing ˜40″ exposure and the UV lamp system emitted light at 196 nm and at 22 watts. For this experiment, there was one UV lamp. The exposure time i.e., reaction time for each of the batches was varied from 8 to 60 seconds depending on gas flow rate. The gas flow rate was set to about 150-1040 mL/min.

After the reaction, gas was passed through an H₂S sensor. H₂S concentration at the end of that time was measured and the % reduction of H₂S was measured. A 6-65% H₂S reduction was observed using the method. We speculate that the variability is due to the variation in exposure (from 8 to about 60 seconds), and variation in gas flow rate, such distinction in reduction of H₂S gas measured was observed. Thus, by increasing the exposure time and/or the wattage for the reaction of H₂S with olefin under UV light, % reduction of H₂S in the methane gas feed can be even greater.

### Prophetic Example 1

The above proof-of-concept experiment can be carried out using various alkanes or alkenes to determine which might be optimal. The experimental design will be the same as that above, with 500 ppm H₂S with the pure hydrocarbon indicated in Table 1. If needed, the reactor temperature is increased to place the hydrocarbons into a gaseous phase, otherwise it is at room temperature (RT).

TABLE 1
H₂S reduction in a 500 ppm with various gas streams

| | | |
|---|---|---|
| | Temperature | |
| Hydrocarbon | (° C.) | % Reduction of H₂S in 60 min |

| | |
|---|---|
| methane | RT |
| ethane | RT |
| propane | RT |
| CO₂ | RT |
| ethylene | RT |
| propylene | RT |
| butene | RT |
| but-2-ene | RT |
| isobutene | RT |
| benzene | 80° C. |

We expect that all alkanes and alkenes will work to some degree and tradeoff between cost, efficiency and reaction temperature may result in a preference for smaller to midsized molecules, and under the current commercial constraints, gases already present in the sour gas stream may be the most cost effective. If some chemicals are slow to react, a photo-initiator may be added.

### Prophetic Example 2

The measurement of H₂S reduction can be conducted to obtain an optimal reaction time in the reactor loop for varying hydrocarbons at a given wattage. Table 2 shows proposed experiments that can be tested as above, by varying the reaction time of H₂S with hydrocarbons. We anticipate that at longer reaction times, the reaction of H₂S to convert said hydrocarbon to mercaptan will reach completion and no H₂S will remain in the gas stream. An optimal time period for each hydrocarbons used can be established easily be merely adding a sample port to the loop and withdrawing samples for measurement at the correct time. Alternatively, an H₂S sensor can continually monitor H₂S levels as the reactions proceeds and that data recorded. In addition, the experiment can be repeated at varying wattage and/or with added photoinitiators.

TABLE 3
500 ppm H₂S reduction in a variable gas
stream treated with 22 Watts UV light

| | | |
|---|---|---|
| | Temperature | % Reduction of H₂S in 30, 60, |
| Hydrocarbon | (° C.) | 120, and 180 seconds |

| | |
|---|---|
| methane | RT |
| ethane | RT |
| propane | RT |
| CO₂ | RT |
| ethylene | RT |
| propylene | RT |
| butene | RT |
| but-2-ene | RT |
| isobutene | RT |
| benzene | 80° C. |
| sour gas from well 1 | RT |
| sour gas from well 2 | RT |

The examples herein are intended to be illustrative only, and not unduly limit the scope of the appended claims. Although the present disclosure and its advantages have been described in detail, it should be understood that various changes, substitutions and alterations can be made herein without departing from the scope of the disclosure as defined in the claims.

The following references are incorporated by reference in their entirety for all purposes:
VAUGHAN, W. E. et al. “The photo-addition of hydrogen sulfide to olefinic bonds.” 1942, J. Org. Chem. 07 (6): 472-476.
SCHWAB, A. W., et al. “Free radical addition of hydrogen sulfide to conjugated and nonconjugated methyl esters and to vegetable oils.” 1968, AOCS Meeting, New York.
WO2011083308 Mobile UV light treatment systems and associated methods.
US20150034319 H₂S Scavengers with synergistic corrosion inhibition.
U.S. Pat. No. 4,140,604 Process for preparing mercaptans.

1. A method for removing H₂S from reservoir fluids, said system comprising:
a) separating a produced reservoir fluid into a produced water stream, a crude oil stream and a sour gas stream, said sour gas stream comprising >20 ppm H₂S and one or more alkane(s) or alkene(s) or both;
b) exposing said sour gas stream to sufficient ultraviolet (UV) to convert said H₂S and said one or more alkane(s) or alkene(s) or both to an organosulfur compound and a sweet gas with zero or trace H₂S;
c) optionally removing said organosulfur compound and said zero or trace H₂S from said sweet gas; and
d) storing, distributing or liquifying said sweet gas.

2. The method of claim 1, wherein said organosulfur compound is a mercaptan.

3. The method of claim 1, wherein said organosulfur compound and/or said zero or trace H₂S are removed using a scavenger selected from a group consisting of triazine, or methanolamine (MEA), diethanolamine (DEA), diglycolamine (DGA), methyldiethanolamine (MDEA), and combinations thereof.

4. The method of claim 1, wherein said organosulfur compound and/or said zero or trace H₂S are removed with an absorbent.

5. A system for removing H₂S from reservoir fluids, said system comprising:
a) a separator for separating a produced reservoir fluid into a produced water stream, a crude oil stream and a sour gas stream, said sour gas stream comprising >20 ppm H₂S and one or more alkane(s) or alkene(s);
b) a UV reactor unit comprising a UV transparent piping fluidly connected to said sour-gas stream and having one or more UV lights adjacent said piping and configured to emit sufficient UV light to an interior of said piping to convert said sour gas to an organosulfur compound and a clean gas stream;
c) said organosulfur compound and clean gas stream fluidly connected to a storage or distribution system.

6. The system of claim 5, wherein said UV reactor unit is contained within a housing, and said housing is purged with an inert gas.

7. The system of claim 5, wherein said UV reactor unit is contained within a housing, and said housing is purged with helium.

8. The system of claim 5, wherein said housing is UV opaque.

9. The system of claim 6, wherein said housing is UV opaque.

10. The system of claim 5, further comprising an H₂S sensor upstream of said UV reactor unit, or an H₂S sensor downstream of said UV-reactor unit or both.

11. The system of claim 5, further comprising an H₂S sensor upstream of said UV reactor unit, or an H₂S sensor downstream of said UV-reactor unit or both.

12. The system of claim 5, wherein said piping comprises acrylic or quartz glass.

13. The system of claim 5, said UV reactor comprising a heater or being insulated.

14. The system of claim 5, further comprising one or more of:
a) a demister upstream of said UV reactor unit;
b) a primary gas treatment unit upstream of said UV reactor unit;
c) as mixer upstream of said UV reactor unit;
d) a debutanizer upstream of said UV reactor unit;
e) a scrubber upstream of said storage or distribution system for removing said organosulfur compound; or
f) an LNG liquefaction unit upstream of said storage or distribution system for liquifying said clean gas stream.
